(19) United States
(12) Patent Application Publication
(10) Pub. No.: US 2014/0165089 A1
(43) Pub. Date: Jun. 12, 2014

(54) CHANNEL MANAGEMENT

(71) Applicant: KT Corporation, Seongnam-si (KR)

(72) Inventors: Hoon-Kyu Park, Suwon-si (KR); Han-Wook Jung, Seoul (KR); Donghyun Jang, Seoul (KR); Yeong-joon Jeong, Seoul (KR)

(73) Assignee: KT Corporation, Seongnam-si (KR)

(21) Appl. No.: 14/102,926

(22) Filed: Dec. 11, 2013

(30) Foreign Application Priority Data
Dec. 11, 2012 (KR) 10-2012-0143235

(51) Int. Cl. H04N 21/266; H04N 21/8352

(52) U.S. Cl. CPC H04N 21/26606; H04N 21/8352
USPC 725/25

(57) ABSTRACT

In one example embodiment, a system includes a channel management server configured to: receive, from a broadcasting service provider, a request to generate a broadcast channel identifier that corresponds to broadcast content provided by the broadcasting service provider, and generate the broadcast channel identifier based at least in part on information regarding the broadcasting service provider and the broadcast content; and an end device configured to: receive the broadcast channel identifier.

### TECHNICAL FIELD

The embodiments described herein pertain generally to management of multiple broadcast channels.

### BACKGROUND

An IPTV (Internet Protocol Television) service provider may provide a service that integrates security of a telecommunication network, the content of a broadcast television network, and the ubiquity of the Internet; and may further provide voice, data, and video services over one connection simultaneously. Therefore, a user may use a client device to not only access the Internet, and watch TV, but also enjoy more data, voice, and video integrated services through the IPTV service, serially or in parallel.

### SUMMARY

In one example embodiment, a system may include a channel management server configured to: receive, from a broadcasting service provider, a request to generate a broadcast channel identifier that corresponds to broadcast content provided by the broadcasting service provider, and generate the broadcast channel identifier based at least in part on information regarding the broadcasting service provider and the broadcast content; and an end device configured to: receive the broadcast channel identifier.

In another example embodiment, a server may include a request receiver configured to receive, from a broadcasting service provider, a request to generate a broadcast channel identifier that corresponds to broadcast content provided by the broadcasting service provider; a channel identifier generator configured to generate the broadcast channel identifier based at least in part on information regarding the broadcasting service provider and the broadcast content; and a channel identifier transmitter configured to transmit the generated broadcast channel identifier.

In yet another example embodiment, a method implemented by a server may include: receiving, from a broadcasting service provider, a request to generate a broadcast channel identifier that corresponds to broadcast content provided by the broadcasting service provider; generating the broadcast channel identifier based at least in part on information regarding the broadcasting service provider and the broadcast content; and transmitting the generated broadcast channel identifier.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system configuration by which channel management may be implemented, in accordance with various embodiments described herein;

FIG. 2 shows an illustrative example of broadcast channel identifier data by which at least portions of channel management may be implemented, in accordance with various embodiments described herein;

FIG. 3 shows an example configuration of a channel management server by which at least portions of channel management may be implemented, in accordance with various embodiments described herein;

FIG. 4 shows an example processing flow of operations by which at least portions of channel management may be implemented, in accordance with various embodiments described herein;

FIG. 5 shows another example processing flow of operations by which at least portions of channel management may be implemented, in accordance with various embodiments described herein;

FIG. 6 shows still another example processing flow of operations by which at least portions of channel management may be implemented, in accordance with various embodiments described herein;

FIG. 7 shows still another example processing flow of operations by which at least portions of channel management may be implemented, in accordance with various embodiments described herein; and

FIG. 8 shows an illustrative computing embodiment, in which any of the processes and sub-processes of a channel management scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

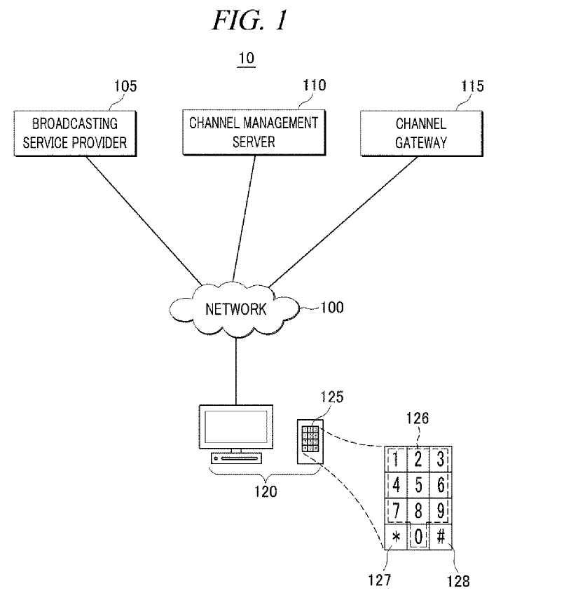

FIG. 1 shows an example system configuration 10 by which channel management may be implemented, in accordance with various embodiments described herein. As depicted in FIG. 1, system configuration 10 may include, at least, a broadcasting service provider 105, a channel management server 110, a channel gateway 115, and an end device 120.

Network 100 may refer to a component or module that may be configured to communicatively couple two or more of broadcasting service provider 105, channel management server 110, channel gateway 115, and end device 120. Non-limiting examples of network 100 may include a wired network protocol, such as LAN (Local Area Network), WAN (Wide Area Network), VAN (Value Added Network), etc.; or various other wireless network protocols, such as a mobile radio communication network including at least one of a 3rd generation (3G) mobile telecommunications network, a 4th or 5^{th} generation (4G) mobile telecommunications network, any other mobile telecommunications networks, a satellite network, WiBro (Wireless Broadband Internet), Mobile WiMAX, HSDPA (High Speed Downlink Packet Access) or the like.

Broadcasting service provider 105 may refer to one or more servers that may be hosted on or by an organization or entity that generates broadcast content. Further, broadcasting service provider 105 may host or include one or more broadcasting devices or systems to broadcast the generated broadcast content to end device 120.

In accordance with at least one example embodiment, broadcasting service provider 105 may refer to an entity that may be configured to provide generated broadcast content to a closed user group according to a broadcasting policy of broadcasting service provider 105. In at least some embodiments, the user group may be a group that may be restricted to, e.g., subscribers. Regardless, whether the user group is closed or not, the user group may include at least one end device that may be owned or controlled by a user or entity who is affiliated with a certain group. For example, but not as a limitation, the certain group may include a school; corporate entity; civic organization, e.g., church; etc. That is, in some embodiments, broadcasting service provider 105 may be configured to provide the broadcast content to the at least one restricted end device that is affiliated with the certain group.

In accordance with at least one alternative embodiment, broadcasting service provider 105 may be configured to provide the broadcast content to an open user group according to the broadcasting policy of broadcasting service provider 105. That is, broadcasting service provider 105 may be configured to have no restrictions regarding broadcasting service recipients, and therefore provide the broadcast content to all end devices that are capable of receiving the broadcast content.

Broadcasting service provider 105 may be further configured to transmit, to channel management server 110, a request to generate a broadcast channel identifier that corresponds to the broadcast content to be provided by broadcasting service provider 105. In accordance with some embodiments, the request to generate the broadcast channel identifier may be accompanied by information regarding broadcasting service provider 105 and/or the broadcast content provided by broadcasting service provider 105. For example, the information regarding broadcasting service provider 105 may include a broadcasting policy that indicates whether broadcasting service provider 105 is configured to provide the broadcast content to the closed user group or to the open user group. Further, the information regarding the broadcast content may include at least one of a type of the broadcast content or a genre of the broadcast content. For example, but not as a limitation, the type of the broadcast content may include at least one of a real-time broadcast, video-on-demand, music, or interactive content.

Further, in some embodiments, broadcasting service provider 105 may be configured to receive, from channel management server 110, a request for broadcast content. The request for broadcast content may be transmitted to channel management server 110 from end device 120. Broadcasting service provider 105 may be further configured to authenticate end device 120 that requested the broadcast content based on authentication information of end device 120. Non-limiting examples of the authentication information may include an internet protocol (IP) address of end device 120, a serial number assigned to end device 120, or a unique identifier of end device 120. Further, broadcasting service provider 105 may be configured to transmit, to authenticated end device 120, the requested broadcast content, and then the broadcast content may be played, or otherwise reproduced, on end device 120.

Further, in some embodiments, broadcasting service provider 105 may be configured to transmit, to channel management server 110 or any other entity that may be equipped with broadcasting devices or systems, a request to host the broadcasting devices or systems to transmit the broadcast content to end device 120. For instance, such transmission may occur if broadcasting service provider 105 is unable to broadcast the broadcast content.

Channel management server 110 may refer to one or more servers or other apparatuses that may be configured to manage broadcast channel identifiers and corresponding broadcast content. As non-limiting examples, channel management server 110 may be hosted on one or more of an Internet service provider (ISP); application service provider (ASP); storage service provider (SSP); and television service provider, i.e., cable TV, DSL and DBS, etc.

Channel management server 110 may refer to one or more servers or other apparatuses that may be hosted and/or supported by a service providing organization or entity that provides real-time broadcasting services, video-on-demand (VOD) services, and/or user interactive services (e.g., games) to end device 120 or by any other entity that may be configured to manage broadcast channel identifiers and corresponding broadcast content. Further, channel management server 110 may be configured to receive, from broadcasting service provider 105, a request to generate a broadcast channel identifier that corresponds to broadcast content provided by broadcasting service provider 105. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash, i.e., pound, sign selectable through a hash key or other non-alphanumeric signs selectable through other non-alphanumeric function keys.

Further, in response to the received request from broadcasting service provider 105, channel management server 110 may be configured to generate the broadcast channel identifier based at least in part on the information regarding broadcasting service provider 105. In some embodiments, channel management server 110 may be configured to determine whether broadcasting service provider 105 provides the broadcast content to the closed user group or to the open user group based on the broadcasting policy of broadcasting service provider 105. Channel management server 110 may be configured then to generate a broadcast channel identifier that includes one of the asterisk sign or the hash sign, if broadcasting service provider 105 is determined to provide the broadcast content to the closed user group. Further, channel management server 110 may be configured then to generate a broadcast channel identifier that includes the other one of the hash sign or the asterisk sign or if broadcasting service provider 105 is determined to provide the broadcast content to the open user group.

Further and/or alternatively, also in response to the received request from broadcasting service provider 105, channel management server 110 may be configured to generate the broadcast channel identifier based at least in part on the type of the broadcast content and the genre of the broadcast content. For example, but not as a limitation, the type of the broadcast content may include at least one of a real-time broadcast, video-on-demand, music, or interactive content. By way of example, but not as a limitation, if broadcasting service provider 105 provides video-on-demand (VOD) content regarding education content to the closed user group (e.g., an elementary school), channel management server 110 may be configured to generate a broadcast channel identifier of “*0101001” by combining “the asterisk sign (*)” that indicates that broadcasting service provider 105 provides the broadcast content to the closed user group (e.g., a school), “01” that indicates the broadcast content is used for an elementary school or student, “01” that indicates that the type of the broadcast content is VOD content and “001” that indicates that the genre of the broadcast content is education content. Although the broadcast channel identifier is described to have eight digits, one skilled in the art will appreciate that digits of the broadcast channel identifier are not to be so limited in any manner. Channel management server 110 may be configured to determine and/or change the digits of the broadcast channel identifier depending on at least one of the broadcasting policy of broadcasting service provider 105, the type of the broadcast content or the genre of the broadcast content.

Further and/or alternatively, also in response to the received request from broadcasting service provider 105, channel management server 110 may be configured to generate the broadcast channel identifier to include a telephone number or a unique identification number of an entity that controls operations of broadcasting service provider 105 (e.g., a telephone number of the elementary school).

In some embodiments, channel management server 110 may be configured to transmit the generated broadcast channel identifier to channel gateway 115 and/or end device 120 via network 100.

In some embodiments, channel management server 110 may be configured to receive, from end device 120 a request for broadcast content that corresponds to the broadcast channel identifier. Further, channel management server 110 may be configured to detect and determine a broadcasting service provider that provides the requested broadcast content (e.g., broadcasting service provider 105). Channel management server 110 may be configured to then transmit, to broadcasting service provider 105, the received request for the broadcast content. Broadcasting service provider 105 may be configured to then transmit the broadcast content to end device 120.

In some embodiments, channel management server 110 may be configured to authenticate end device 120, for example when the broadcast content was requested of channel management server 110 based on the authentication information of end device 120. Further, channel management server 110 may be configured to transmit, to authenticated end device 120, the requested broadcast content, and the broadcast content may be reproduced on end device 120.

Channel gateway 115 may refer to one or more servers or other apparatuses that may be hosted and/or supported by a service providing organization or entity that provides real-time broadcasting services, video-on-demand (VOD) services, and/or user interactive services (e.g., games) to end device 120 or by any other entity that may be configured to manage broadcast channel identifiers and corresponding broadcast content. Further, channel gateway 115 may refer to one or more servers or apparatuses that may be configured to transmit broadcast channel identifiers and requests for broadcast content corresponding to the broadcast channel identifiers between two or more of broadcasting service provider 105, channel management server 110 and end device 120. Channel gateway 115 may be further configured, from channel management server 110, to receive the broadcast channel identifier, and to transmit the received broadcast channel identifier to end device 120. Further, channel gateway 115 may be configured to receive, from end device 120 a request for broadcast content that corresponds to the broadcast channel identifier. Further still, channel gateway 115 may be configured to detect and determine a broadcasting service provider that provides the requested broadcast content (e.g., broadcasting service provider 105). Channel gateway 115 may be configured to then transmit, to broadcasting service provider 105, the received request for the broadcast content. By way of example, channel gateway 115 may be configured to transmit the received request for the broadcast content to broadcasting service provider 105 by using a redirection signal or method.

End device 120 may refer to one or more client devices or other apparatuses that may be controlled by a user or an entity who subscribes to a broadcasting service. Further, end device 120 may be configured to receive the broadcast channel identifier from at least one of channel management server 110 or channel gateway 115. Further, end device 120 may be configured to transmit a request for broadcast content corresponding to the broadcast channel identifier to at least one of channel management server 110 or channel gateway 115.

In some embodiments, end device 120 may include a keyboard, a remote controller or a smart phone that has a keypad or a touch based keypad interface. For example, but not as a limitation, as depicted in FIG. 1, end device 120 may include a keypad 125. Keypad 125 may include alphanumeric keys 126 and at least one non-numeric character keys such as an asterisk key 127 and a hash key 128. End device 120 may be configured to generate the request for the broadcast content when end device 120 receives inputs to indicate the broadcast channel identifier corresponding to the broadcast channel via keypad 125. By way of example, but not as a limitation, end device 120 may be configured to receive an input regarding broadcast channel identifier that includes at least one numeral selected through alphanumeric keys 126 and at least one of an asterisk sign selected through asterisk key 127 or a hash sign selected through hash key 128.

Further, end device 120 may be configured to transmit the authentication information of end device 120 to at least one of broadcasting service provider 105 or channel management server 110. Non-limiting examples of the authentication information may include an Internet protocol (IP) address of end device 120, a serial number assigned to end device 120, or a unique identifier of end device 120. Further, end device 120 may be configured to receive the requested broadcast content from at least one of broadcasting service provider 105 or channel management server 110, and to reproduce the received broadcast content.

For example, but not as a limitation, end device 120 may refer to a notebook computer; a personal computer; a smart phone; a tablet computer; a phablet device; and/or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Thus, FIG. 1 shows example system configuration 10 in which one or more embodiments of a channel management scheme may be implemented, in accordance with various embodiments described herein.

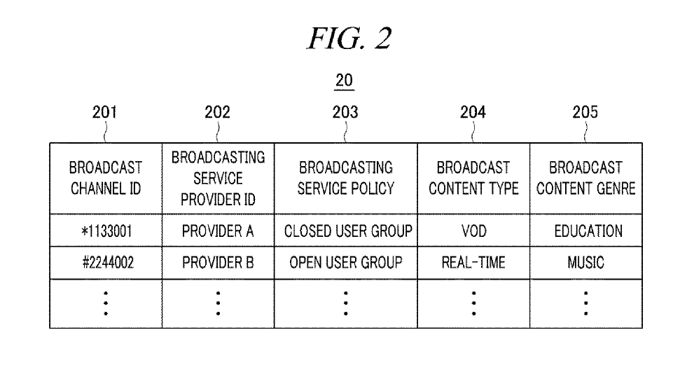

FIG. 2 shows an illustrative example of broadcast channel identifier data by which at least portions of channel management may be implemented, in accordance with various embodiments described herein.

In some embodiments, channel management server 110 may be configured to generate multiple broadcast channel identifiers based at least in part on a broadcasting policy of broadcasting service provider 105, a type of broadcast content provided by broadcasting service provider 105 and a genre of the broadcast content. The broadcasting policy may indicate whether broadcasting service provider 105 is to provide the broadcast content to a closed user group or an open user group. Further, channel management server 110 may be configured to generate and store, in a memory, broadcast channel identifier data 20 that includes the generated multiple broadcast channel identifiers in association with the broadcasting policy, the type of the broadcast content and the genre of the broadcast content. Further, channel management server 110 may be configured to transmit broadcast channel identifier data 20 to at least one of channel gateway 115 or end device 120. For example, but not as a limitation, as depicted in FIG. 2, broadcast channel identifier data 20 may include information regarding a broadcast channel identifier 201, a broadcasting service provider identifier 202, a broadcasting service policy 203, a broadcast content type 204 and a broadcast content genre 205. However, kinds of information included in broadcast channel identifier data 20 may be changed.

Thus, FIG. 2 shows an illustrative example of broadcast channel identifier data 20 by which at least portions of channel management may be implemented, in accordance with various embodiments described herein.

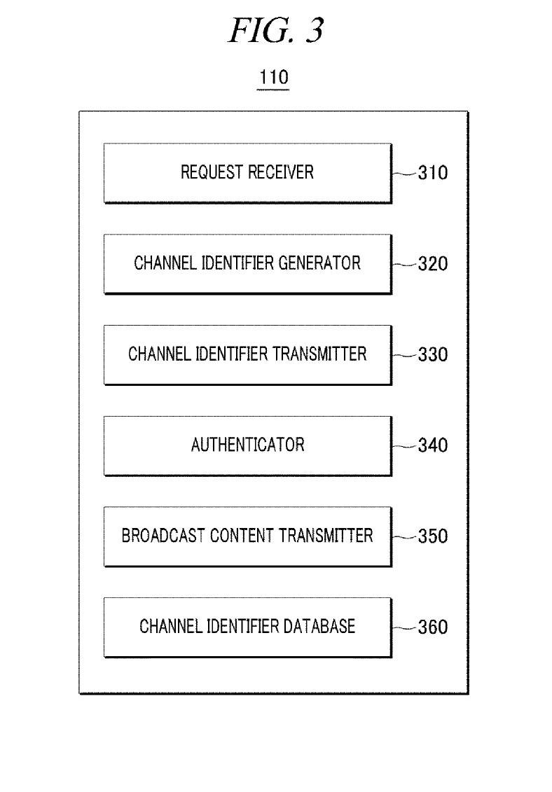

FIG. 3 shows an example configuration of a channel management server 110 by which at least portions of channel management may be implemented, in accordance with various embodiments described herein. As depicted in FIG. 3, channel management server 110 may include a request receiver 310, a channel identifier generator 320, a channel identifier transmitter 330, an authenticator 340, a broadcast content transmitter 350 and a channel identifier database 360. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of request receiver 310, channel identifier generator 320, channel identifier transmitter 330, authenticator 340, broadcast content transmitter 350 and channel identifier database 360 may be included in an instance of an application hosted on channel management server 110.

Request receiver 310 may be configured to receive, from broadcasting service provider 105, a request to generate a broadcast channel identifier that corresponds to broadcast content provided by broadcasting service provider 105. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash, i.e., pound, sign selectable through a hash key or other non-alphanumeric signs selectable through other non-alphanumeric function keys.

Further, in some embodiments, request receiver 310 may be configured to receive, from end device 120 a request for the broadcast content that corresponds to the broadcast channel identifier. Further, request receiver 310 may be configured to detect and determine a broadcasting service provider that provides the requested broadcast content (e.g., broadcasting service provider 105). Request receiver 310 may be configured to then transmit, to determined broadcasting service provider 105, the received request for the broadcast content. In some other embodiments, request receiver 310 may be configured to receive the request for the broadcast content from channel gateway 115 that receives the request for the broadcast content from end device 120.

Channel identifier generator 320 may be configured to generate the broadcast channel identifier based at least in part on information regarding broadcasting service provider 105 and the broadcast content. In some embodiments, the information may include a broadcasting policy of broadcasting service provider 105, a type of the broadcast content and a genre of the broadcast content.

Channel identifier generator 320 may be further configured to determine whether broadcasting service provider 105 is to provide the broadcast content to a closed user group or an open user group based on the broadcasting policy of broadcasting service provider 105. Channel identifier generator 320 may be configured to generate a broadcast channel identifier that includes one of the asterisk sign or the hash sign, if broadcasting service provider 105 is determined to provide the broadcast content to the closed user group. Further, channel identifier generator 320 may be configured to generate a broadcast channel identifier that includes the other one of the hash sign or the asterisk sign, if broadcasting service provider 105 is determined to provide the broadcast content to the open user group.

In some embodiments, channel identifier transmitter 330 may be configured to transmit the generated broadcast channel identifier to channel gateway 115. In some other embodiments, channel identifier transmitter 330 may be configured to transmit the generated broadcast channel identifier to end device 120.

Authenticator 340 may be configured to authenticate end device 120 that requested the broadcast content based on authentication information of end device 120. Non-limiting examples of the authentication information of end device 120 may include an internet protocol (IP) address of end device 120, a serial number assigned to end device 120, or a unique identifier of end device 120.

Broadcast content transmitter 350 may be configured to transmit the requested broadcast content to end device 120. In some embodiments, broadcast content transmitter 350 may be configured to receive, from broadcasting service provider 105 a request for hosting broadcasting devices or systems to transmit the broadcast content and a request for transmitting the broadcast content to end device 120. Such transmission may occur, for example, if broadcasting service provider 105 is unable to broadcast the requested broadcast content.

Channel identifier database 360 may be configured to store broadcast channel identifier data regarding multiple broadcast channel identifiers that are generated by channel identifier generator 320. For example, but not as a limitation, channel identifier database 360 may be configured to store the multiple broadcast channel identifiers in association with the broadcasting policy, the type of the broadcast content and the genre of the broadcast content.

Thus, FIG. 3 shows an example configuration of channel management server 110 by which at least portions of channel management may be implemented, in accordance with various embodiments described herein.

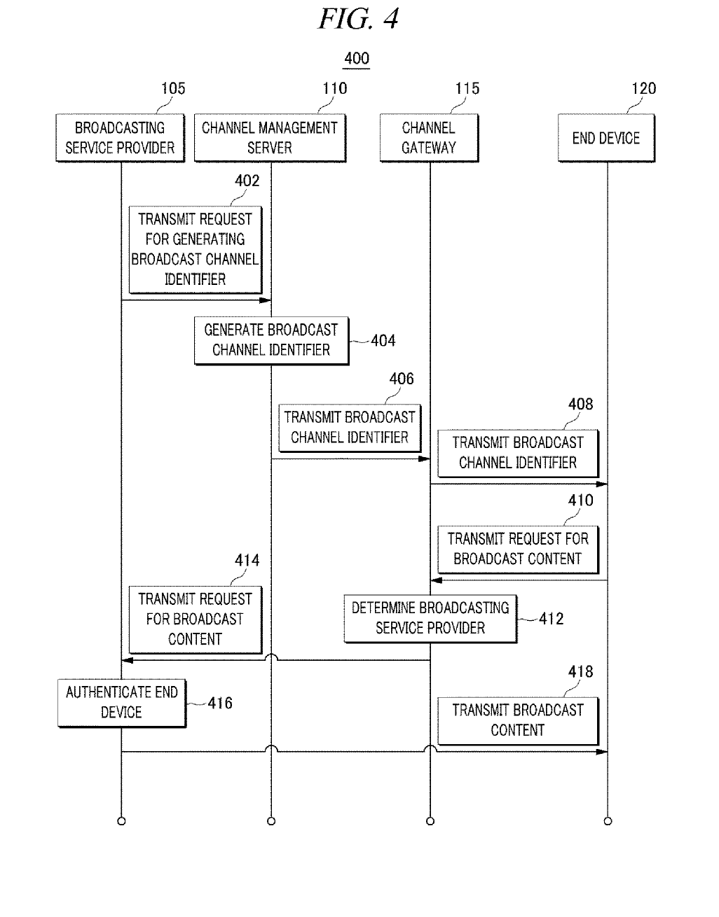

FIG. 4 shows an example processing flow 400 of operations by which at least portions of channel management may be implemented, in accordance with various embodiments described herein. The operations of processing flow 400 may be implemented in system configuration 10 including broadcasting service provider 105, channel management server 110, channel gateway 115 and end device 120, as illustrated in FIG. 1. Processing flow 400 may include one or more operations, actions, or functions as illustrated by one or more blocks 402, 404, 406, 408, 410, 412, 414, 416 and/or 418. Although illustrated as discrete blocks, various blocks may be divided into additional blocks, combined into fewer blocks, or eliminated, depending on the desired implementation. Processing may begin at block 402.

Block 402 (Transmit Request for Generating Broadcast Channel Identifier) may refer to broadcasting service provider 105 transmitting, to channel management server 110, a request to generate a broadcast channel identifier that corresponds to broadcast content provided by broadcasting service provider 105. Processing may proceed from block 402 to block 404.

Block 404 (Generate Broadcast Channel Identifier) may refer to channel management server 110 generating the broadcast channel identifier based at least in part on information regarding broadcasting service provider 105 and the broadcast content. In some embodiments, the information may include a broadcasting policy of broadcasting service provider 105, a type of the broadcast content and a genre of the broadcast content. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash sign selectable through a hash key or other non-alphanumeric signs selectable through other non-alphanumeric function keys. Processing may proceed from block 404 to block 406.

Block 406 (Transmit Broadcast Channel Identifier) may refer to channel management server 110 transmitting the broadcast channel identifier generated at block 404 to channel gateway 115. Processing may proceed from block 406 to block 408.

Block 408 (Transmit Broadcast Channel Identifier) may refer to channel gateway 115 transmitting the broadcast channel identifier received at block 406 to end device 120. Processing may proceed from block 408 to block 410.

Block 410 (Transmit Request for Broadcast Content) may refer to end device 120 transmitting, to channel gateway 115, a request for the broadcast content corresponding to the broadcast channel identifier. For example, but not as a limitation, end device 120 may include a keypad that includes alphanumeric keys, an asterisk key and a hash key. End device 120 may generate the request for the broadcast content when end device 120 receives an input regarding the broadcast channel identifier that includes at least one numeral selected through the alphanumeric keys and at least one of an asterisk sign selected through the asterisk key or a hash sign selected through the hash key. Processing may proceed from block 410 to block 412.

Block 412 (Determine Broadcasting Service Provider) may refer to channel gateway 115 detecting and determining broadcasting service provider 105 that provides the broadcast content requested at block 410. Processing may proceed from block 412 to block 414.

Block 414 (Transmit Request for Broadcast Content) may refer to channel gateway 115 transmitting the request for the broadcast content, which is received at block 410, to broadcasting service provider 105, which has been determined at block 412. By way of example, channel gateway 115 may transmit the received request for the broadcast content to broadcasting service provider 105 by using a redirection signal or method. Processing may proceed from block 414 to block 416.

Block 416 (Authenticate End Device) may refer to broadcasting service provider 105 authenticating end device 120 that requested the broadcast content based on authentication information of end device 120. Non-limiting examples of the authentication information may include an internet protocol (IP) address of end device 120, a serial number assigned to end device 120, or a unique identifier of end device 120. Processing may proceed from block 416 to block 418.

Block 418 (Transmit Broadcast Content) may refer to broadcasting service provider 105 transmitting, to end device 120 authenticated at block 416, the requested broadcast content. Then, the broadcast content may be reproduced on end device 120.

Thus, FIG. 4 shows an example processing flow 400 of operations by which at least portions of channel management may be implemented, in accordance with various embodiments described herein.

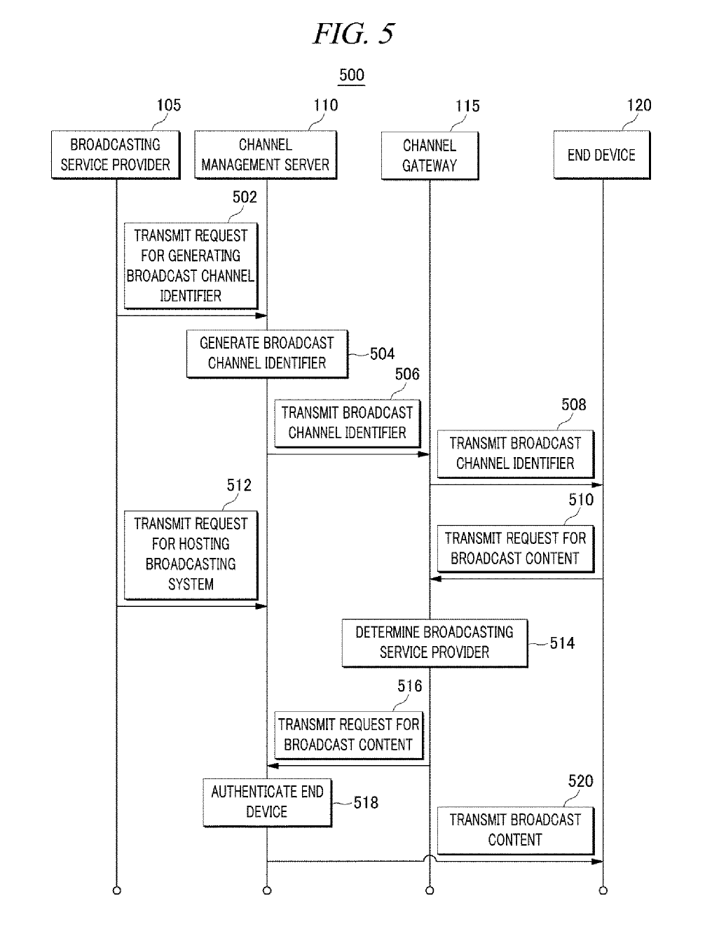

FIG. 5 shows another example processing flow 500 of operations by which at least portions of channel management may be implemented, in accordance with various embodiments described herein. The operations of processing flow 500 may be implemented in system configuration 10 including broadcasting service provider 105, channel management server 110, channel gateway 115 and end device 120, as illustrated in FIG. 1. Processing flow 500 may include one or more operations, actions, or functions as illustrated by one or more blocks 502, 504, 506, 508, 510, 512, 514, 516 and/or 518. Although illustrated as discrete blocks, various blocks may be divided into additional blocks, combined into fewer blocks, or eliminated, depending on the desired implementation. Processing may begin at block 502.

Block 502 (Transmit Request for Generating Broadcast Channel Identifier) may refer to broadcasting service provider 105 transmitting, to channel management server 110, a request to generate a broadcast channel identifier that corresponds to broadcast content provided by broadcasting service provider 105. Processing may proceed from block 502 to block 504.

Block 504 (Generate Broadcast Channel Identifier) may refer to channel management server 110 generating the broadcast channel identifier based at least in part on information regarding broadcasting service provider 105 and the broadcast content. In some embodiments, the information may include a broadcasting policy of broadcasting service provider 105, a type of the broadcast content and a genre of the broadcast content. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash sign selectable through a hash, i.e., pound, key or other non-alphanumeric signs selectable through other non-alphanumeric function keys. Processing may proceed from block 504 to block 506.

Block 506 (Transmit Broadcast Channel Identifier) may refer to channel management server 110 transmitting the broadcast channel identifier generated at block 504 to channel gateway 115. Processing may proceed from block 506 to block 508.

Block 508 (Transmit Broadcast Channel Identifier) may refer to channel gateway 115 transmitting the broadcast channel identifier received at block 506 to end device 120. Processing may proceed from block 508 to block 510.

Block 510 (Transmit Request for Broadcast Content) may refer to end device 120 transmitting, to channel gateway 115, a request for the broadcast content corresponding to the broadcast channel identifier. For example, end device 120 may include a keypad that includes alphanumeric keys, an asterisk key and a hash key. End device 120 may generate the request for the broadcast content when end device 120 receives an input regarding the broadcast channel identifier that includes at least one numeral selected through the alphanumeric keys and at least one of an asterisk sign selected through the asterisk key or a hash sign selected through the hash key. Processing may proceed from block 510 to block 512.

Block 512 (Transmit Request for Hosting Broadcasting System) may refer to broadcasting service provider 105 transmitting, to channel management server 110, a request to host broadcasting systems or devices for transmitting the broadcast content to end device 120. Processing may proceed from block 512 to block 514.

Block 514 (Determine Broadcasting Service Provider) may refer to channel gateway 115 detecting and determining broadcasting service provider 105 that provides the requested broadcast content. Processing may proceed from block 514 to block 516.

Block 516 (Transmit Request for Broadcast Content) may refer to channel gateway 115 transmitting the request for the broadcast content, which is received at block 510, to channel management server 110. By way of example, channel gateway 115 may transmit the received request for the broadcast content to channel management server 110 by using a redirection signal or method. Processing may proceed from block 516 to block 518.

Block 518 (Authenticate End Device) may refer to channel management server 110 authenticating end device 120 that requested the broadcast content based on authentication information of end device 120. Non-limiting examples of the authentication information may include an internet protocol (IP) address of end device 120, a serial number assigned to end device 120, or a unique identifier of end device 120. Processing may proceed from block 518 to block 520.

Block 520 (Transmit Broadcast Content) may refer to channel management server 110 transmitting, to end device 120 authenticated at block 518, the requested broadcast content. Then, the broadcast content may be reproduced on end device 120.

Thus, FIG. 5 shows another example processing flow 500 of operations by which at least portions of channel management may be implemented, in accordance with various embodiments described herein.

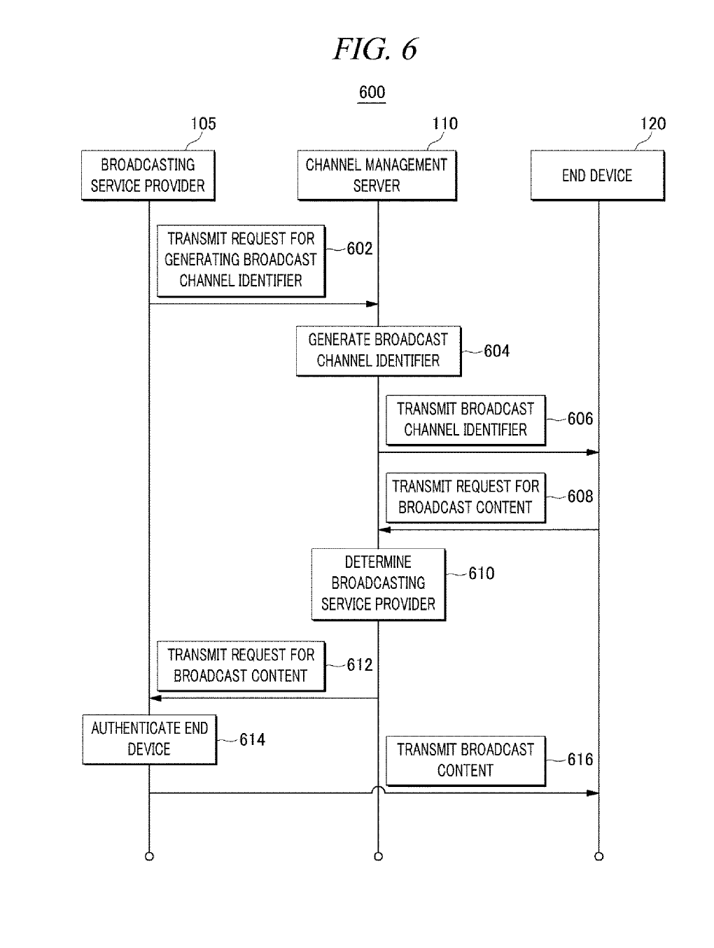

FIG. 6 shows still another example processing flow 600 of operations by which at least portions of channel management may be implemented, in accordance with various embodiments described herein. The operations of processing flow 600 may be implemented in system configuration 10 including broadcasting service provider 105, channel management server 110, end device 120, as illustrated in FIG. 1. Processing flow 600 may include one or more operations, actions, or functions as illustrated by one or more blocks 602, 604, 606, 608, 610, 612, 614 and/or 616. Although illustrated as discrete blocks, various blocks may be divided into additional blocks, combined into fewer blocks, or eliminated, depending on the desired implementation. Processing may begin at block 602.

Block 602 (Transmit Request for Generating Broadcast Channel Identifier) may refer to broadcasting service provider 105 transmitting, to channel management server 110, a request to generate a broadcast channel identifier that corresponds to broadcast content provided by broadcasting service provider 105. Processing may proceed from block 602 to block 604.

Block 604 (Generate Broadcast Channel Identifier) may refer to channel management server 110 generating the broadcast channel identifier based at least in part on information regarding broadcasting service provider 105 and the broadcast content. In some embodiments, the information may include a broadcasting policy of broadcasting service provider 105, a type of the broadcast content and a genre of the broadcast content. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash, i.e., pound, sign selectable through a hash key or other non-alphanumeric signs selectable through other non-alphanumeric function keys. Processing may proceed from block 604 to block 606.

Block 606 (Transmit Broadcast Channel Identifier) may refer to channel management server 110 transmitting the broadcast channel identifier generated at block 604 to end device 120. Processing may proceed from block 606 to block 608.

Block 608 (Transmit Request for Broadcast Content) may refer to end device 120 transmitting, to channel management server 110, a request for the broadcast content corresponding to the broadcast channel identifier. For example, end device 120 may include a keypad that includes alphanumeric keys, an asterisk key and a hash key. End device 120 may generate the request for the broadcast content when end device 120 receives an input regarding the broadcast channel identifier that includes at least one numeral selected through the alphanumeric keys and at least one of an asterisk sign selected through the asterisk key or a hash sign selected through the hash key. Processing may proceed from block 608 to block 610.

Block 610 (Determine Broadcasting Service Provider) may refer to channel management server 110 detecting and determining broadcasting service provider 105 that provides the broadcast content requested at block 608. Processing may proceed from block 610 to block 612.

Block 612 (Transmit Request for Broadcast Content) may refer to channel management server 110 transmitting the request for the broadcast content, which is received at block 608, to broadcasting service provider 105, which has been determined at block 610. Processing may proceed from block 612 to block 614.

Block 614 (Authenticate End Device) may refer to broadcasting service provider 105 authenticating end device 120 that requested the broadcast content based on authentication information of end device 120. Non-limiting examples of the authentication information may include an internet protocol (IP) address of end device 120, a serial number assigned to end device 120, or a unique identifier of end device 120. Processing may proceed from block 614 to block 616.

Block 616 (Transmit Broadcast Content) may refer to broadcasting service provider 105 transmitting, to end device 120 authenticated at block 614, the requested broadcast content. Then, the broadcast content may be reproduced on end device 120.

Thus, FIG. 6 shows still another example processing flow 600 of operations by which at least portions of channel management may be implemented, in accordance with various embodiments described herein.

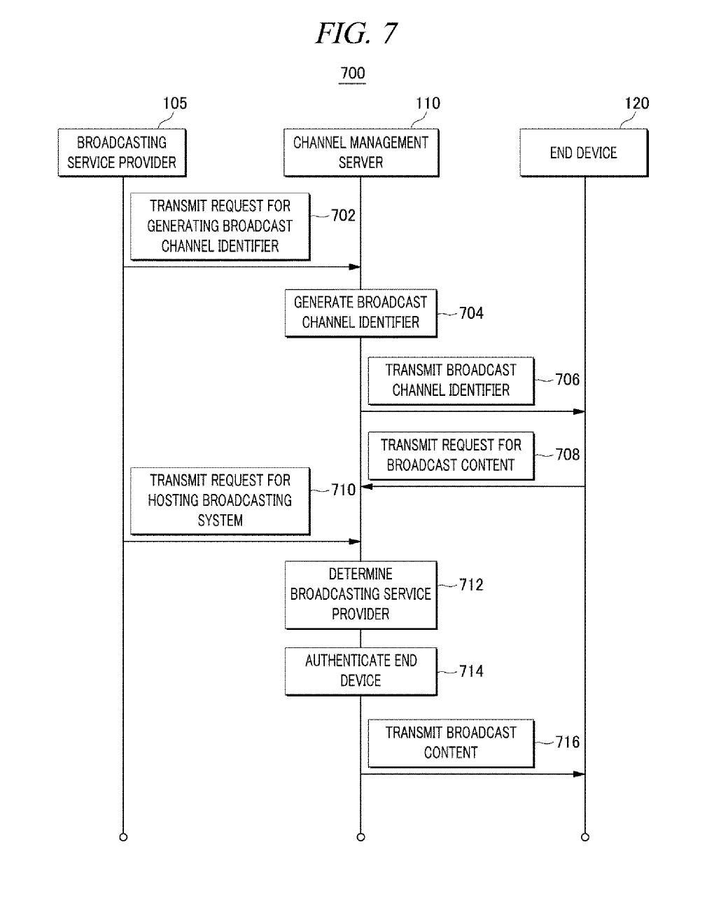

FIG. 7 shows still another example processing flow 700 of operations by which at least portions of channel management may be implemented, in accordance with various embodiments described herein. The operations of processing flow 700 may be implemented in system configuration 10 including broadcasting service provider 105, channel management server 110, end device 120, as illustrated in FIG. 1. Processing flow 700 may include one or more operations, actions, or functions as illustrated by one or more blocks 702, 704, 706, 708, 710, 712, 714 and/or 716. Although illustrated as discrete blocks, various blocks may be divided into additional blocks, combined into fewer blocks, or eliminated, depending on the desired implementation. Processing may begin at block 702.

Block 702 (Transmit Request for Generating Broadcast Channel Identifier) may refer to broadcasting service provider 105 transmitting, to channel management server 110, a request to generate a broadcast channel identifier that corresponds to broadcast content provided by broadcasting service provider 105. Processing may proceed from block 702 to block 704.

Block 704 (Generate Broadcast Channel Identifier) may refer to channel management server 110 generating the broadcast channel identifier based at least in part on information regarding broadcasting service provider 105 and the broadcast content. In some embodiments, the information may include a broadcasting policy of broadcasting service provider 105, a type of the broadcast content and a genre of the broadcast content. For example, but not as a limitation, the broadcast channel identifier may include at least one numeral that is selectable through alphanumeric keys included in a keypad and at least one non-numeric character. Non-limiting examples of the non-numeric character may include at least one of an asterisk sign selectable through an asterisk key, a hash sign selectable through a hash key or other non-alphanumeric signs selectable through other non-alphanumeric function keys. Processing may proceed from block 704 to block 706.

Block 706 (Transmit Broadcast Channel Identifier) may refer to channel management server 110 transmitting the broadcast channel identifier generated at block 704 to end device 120. Processing may proceed from block 706 to block 708.

Block 708 (Transmit Request for Broadcast Content) may refer to end device 120 transmitting, to channel management server 110, a request for the broadcast content corresponding to the broadcast channel identifier. For example, end device 120 may include a keypad that includes alphanumeric keys, an asterisk key and a hash key. End device 120 may generate the request for the broadcast content when end device 120 receives an input regarding the broadcast channel identifier that includes at least one numeral selected through the alphanumeric keys and at least one of an asterisk sign selected through the asterisk key or a hash sign selected through the hash key. Processing may proceed from block 708 to block 710.

Block 710 (Transmit Request for Hosting Broadcasting System) may refer to broadcasting service provider 105 transmitting, to channel management server 110, a request to host broadcasting systems or devices for transmitting the broadcast content to end device 120. Processing may proceed from block 710 to block 712.

Block 712 (Determine Broadcasting Service Provider) may refer to channel management server 110 detecting and determining broadcasting service provider 105 that provides the broadcast content requested at block 708. Processing may proceed from block 712 to block 714.

Block 714 (Authenticate End Device) may refer to channel management server 110 authenticating end device 120 that requested the broadcast content based on authentication information of end device 120. Non-limiting examples of the authentication information may include an internet protocol (IP) address of end device 120, a serial number assigned to end device 120, or a unique identifier of end device 120. Processing may proceed from block 714 to block 716.

Block 716 (Transmit Broadcast Content) may refer to channel management server 110 transmitting, to end device 120 authenticated at block 714, the requested broadcast content. Then, the broadcast content may be reproduced on end device 120.

Thus, FIG. 7 shows still another example processing flow 700 of operations by which at least portions of channel management may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

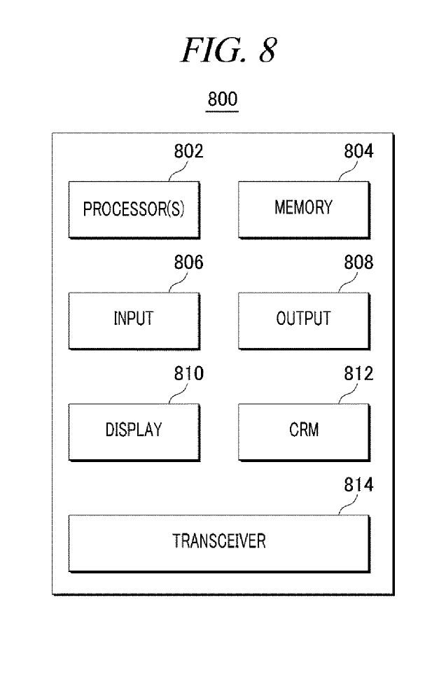

FIG. 8 shows an illustrative computing embodiment, in which any of the processes and sub-processes of a channel management scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 800 may typically include, at least, one or more processors 802, a system memory 804, one or more input components 806, one or more output components 808, a display component 810, a computer-readable medium 812, and a transceiver 814.

Processor 802 may refer to, e.g., a microprocessor, a microcontroller, a digital signal processor, or any combination thereof.

Memory 804 may refer to, e.g., a volatile memory, non-volatile memory, or any combination thereof. Memory 804 may store, therein, an operating system, an application, and/or program data. That is, memory 804 may store executable instructions to implement any of the functions or operations described above and, therefore, memory 804 may be regarded as a computer-readable medium.

Input component 806 may refer to a built-in or communicatively coupled keyboard, touch screen, or telecommunication device. Alternatively, input component 806 may include a microphone that is configured, in cooperation with a voice-recognition program that may be stored in memory 804, to receive voice commands from a user of computing device 800. Further, input component 806, if not built-in to computing device 800, may be communicatively coupled thereto via short-range communication protocols including, but not limitation, radio frequency or Bluetooth.

Output component 808 may refer to a component or module, built-in or removable from computing device 800, that is configured to output commands and data to an external device.

Display component 810 may refer to, e.g., a solid state display that may have touch input capabilities. That is, display component 810 may include capabilities that may be shared with or replace those of input component 806.

Computer-readable medium 812 may refer to a separable machine readable medium that is configured to store one or more programs that embody any of the functions or operations described above. That is, computer-readable medium 812, which may be received into or otherwise connected to a drive component of computing device 800, may store executable instructions to implement any of the functions or operations described above. These instructions may be complimentary or otherwise independent of those stored by memory 804.

Transceiver 814 may refer to a network communication link for computing device 800, configured as a wired network or direct-wired connection. Alternatively, transceiver 814 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system, comprising:
a channel management server configured to:
receive, from a broadcasting service provider, a request to generate a broadcast channel identifier that corresponds to broadcast content provided by the broadcasting service provider, and
generate the broadcast channel identifier based at least in part on information regarding the broadcasting service provider and the broadcast content; and
an end device configured to:
receive the broadcast channel identifier.

2. The system of claim 1, further comprising:
a channel gateway configured to:
receive the broadcast channel identifier from the channel management server, and
transmit the received broadcast channel identifier to the end device.

3. The system of claim 1, wherein the broadcast channel identifier includes at least one numeral and at least one non-numeric character.

4. The system of claim 3, wherein the end device has a keypad including alphanumeric keys, an asterisk key and a hash key,
wherein the numeral is selectable through the alphanumeric keys,
wherein the at least one non-numeric character includes at least one of an asterisk sign or a hash sign selectable through the asterisk key or the hash key,
wherein the end device transmits a request for the broadcasting content corresponding to the broadcasting channel identifier.

5. The system of claim 1, wherein the information regarding the broadcasting service provider includes a broadcasting policy of the broadcasting service provider, and
wherein the broadcasting policy indicates whether the broadcasting service provider provides the broadcast content to a closed user group or an open user group.

6. The system of claim 5, wherein the channel management server is further configured to:
determine that the broadcasting service provider provides the broadcast content to the closed user group based on the broadcasting policy,
generate the broadcast channel identifier to include one of an asterisk sign or a hash sign,
determine that the broadcasting service provider provides the broadcast content to the open user group based on the broadcasting policy, and
generate the broadcast channel identifier to include the other one of the asterisk sign or the hash sign.

7. The system of claim 1, wherein the information regarding the broadcast content includes at least one of a type of the broadcast content or a genre of the broadcast content, and
wherein the type of the broadcast content includes at least one of a real-time broadcast, video-on-demand, music, or interactive content.

8. The system of claim 1, wherein the channel management server is further configured to:
receive, from the end device, a request for the broadcast content corresponding to the broadcast channel identifier, and
transmit, to the broadcasting service provider, the received request for the broadcast content.

9. The system of claim 1, wherein the channel management server is further configured to:
receive, from the end device, a request for the broadcast content corresponding to the broadcast channel identifier,
authenticate the end device, and
transmit the requested broadcast content to the end device.

10. A server, comprising:
a request receiver configured to receive, from a broadcasting service provider, a request to generate a broadcast channel identifier that corresponds to broadcast content provided by the broadcasting service provider;
a channel identifier generator configured to generate the broadcast channel identifier based at least in part on information regarding the broadcasting service provider and the broadcast content; and
a channel identifier transmitter configured to transmit the generated broadcast channel identifier.

11. The server of claim 10, wherein the broadcast channel identifier includes at least one numeral and at least one non-numeric character.

12. The server of claim 11, wherein the at least one non-numeric character includes at least one of an asterisk sign or a hash sign.

13. The server of claim 10, wherein the information includes a broadcast policy of the broadcasting service provider, and
wherein the broadcasting policy indicates whether the broadcasting service provider provides the broadcast content to a closed user group or an open user group.

14. The server of claim 13, wherein the channel identifier generator is further configured to:
determine that the broadcasting service provider provides the broadcast content to the closed user group based on the broadcasting policy,
generate the broadcast channel identifier to include one of an asterisk sign or a hash sign,
determine that the broadcasting service provider provides the broadcast content to the open user group based on the broadcasting policy, and
generate the broadcast channel identifier to include the other one of the asterisk sign or the hash sign.

15. The server of claim 10, wherein the information regarding the broadcast content includes at least one of a type of the broadcast content or a genre of the broadcast content, and
wherein the type of the broadcast content includes at least one of a real-time broadcast, video-on-demand, music, or interactive content.

16. The server of claim 9, wherein the request receiver is further configured to receive a request for the broadcast content corresponding to the broadcast channel identifier, and
wherein the server further comprises:
an authenticator configured to authenticate an end device that requested the broadcast content; and
a broadcast content transmitter configured to transmit the requested broadcast content to the end device.

17. A method performed under control of a server, comprising:
receiving, from a broadcasting service provider, a request to generate a broadcast channel identifier that corresponds to broadcast content provided by the broadcasting service provider;
generating the broadcast channel identifier based at least in part on information regarding the broadcasting service provider and the broadcast content; and
transmitting the generated broadcast channel identifier.

18. The method of claim 17, wherein the broadcast channel identifier includes at least one numeral and at least one of an asterisk sign or a hash sign.

19. The method of claim 18, wherein the information regarding the broadcasting service provider includes a broadcasting policy of the broadcasting service provider,
wherein the broadcasting policy indicates whether the broadcasting service provider provides the broadcast content to a closed user group or an open user group, and
wherein the generating includes:
determining that the broadcasting service provider provides the broadcast content to the closed user group based on the broadcasting policy,
generating the broadcast channel identifier to include one of the asterisk sign or the hash sign,
determining that the broadcasting service provider provides the broadcast content to the open user group based on the broadcasting policy, and
generating the broadcast channel identifier to include the other one of the asterisk sign or the hash sign.

20. The method of claim 17, wherein the information regarding the broadcast content includes at least one of a type of the broadcast content or a genre of the broadcast content, and
wherein the type of the broadcast content includes at least one of a real-time broadcast, video-on-demand, music, or interactive content.
